(19) United States
(12) Patent Application Publication
(10) Pub. No.: US 2025/0272706 A1
(43) Pub. Date: Aug. 28, 2025

(54) DATA ANALYTIC METHOD AND SYSTEM

(71) Applicant: Craig P. Wilson, Ojai, CA (US)

(72) Inventor: Craig P. Wilson, Ojai, CA (US)

(21) Appl. No.: 19/178,752

(22) Filed: Apr. 14, 2025

Related U.S. Application Data
(63) Continuation-in-part of application No. 17/580,520, filed on Jan. 20, 2022.
Application No. 17/580,520 is a continuation of application No. PCT/US2020/034029, filed on May 21, 2020.
(60) Provisional application No. 62/850,862, filed on May 21, 2019.

(51) Int. Cl. G06Q 30/0204; G06F 16/25; G06Q 30/0242

(52) U.S. Cl. CPC G06Q 30/0204; G06F 16/258; G06Q 30/0242

(57) ABSTRACT

The present application discloses a novel data analytic method and an Artificial Intelligence (AI) platform for integrating, analyzing and managing data collected from diverse sources such as channel performance, marketing, and sales. The disclosed data analytic method and platform are developed based on a brand ecosystem model and are designed to provide tools and techniques for analyzing real-time and holistic data quantifying customer loyalty to and customer relationship with a particular product and brand.

### CROSS-REFERENCE TO RELATED APPLICATIONS

This US application is a continuation application of U.S. application Ser. No. 17/580,520 filed on Jan. 20, 2022, which claims priority to the International Application PCT/US2020/034029 filed on May 21, 2020, claiming priority under the Paris Convention to U.S. provisional application 62/850,862 filed on May 21, 2019, and titled The Brand Ecosystem Model Platform, the content of all three applications being incorporated by reference herein in their entirety.

### FIELD OF THE TECHNOLOGY

The present disclosure relates generally to data analysis and more specifically to data and analytic techniques designed to improve the collection and analysis of business intelligence data.

### BACKGROUND

There are many analytic tools available from large computer software companies, such as Adobe, SAP, IBM, etc., that help businesses with collecting and analyzing customer data. These tools are useful in organizing large volumes of data, providing statistical evidence on customer behavior, and generating overall business performance evaluation. These tools can even evaluate the impact of web designs, marketing messages, or advertisement campaigns on sales numbers and profit trends. However, these tools lack the sophistication or intelligence to provide coherent explanation of customer behaviors, let alone advising on means and ways to improve customer loyalty and brand sustainability.

Prior art customer relationship management (CRM) packages can identify correlations between discrete data sets, but are often incapable of providing insights on why customers prefer one brand over another brand and why customers are loyal to one brand while indifferent to or loath another. For example, prior art CRM packages cannot, and probably do not aim to, explain why Harley-Davidson is the number two in the most tattooed symbols, second only to “Mom.” To date, there is not an industry standard measurement of customer loyalty to a brand name.

The present application discloses advantageous data analytic tools and techniques that are built on a new customer-relationship model and are designed to improve business and market intelligence analysis.

### SUMMARY

Accordingly, it is an objective of this application to disclose an innovative data analytic platform and techniques that are designed to improve existing data analytical approaches used for business intelligence data. Existing enterprise software used for marketing and branding does not collect and analyze data in a manner that quantitatively measure the acceptance of a brand name by customers. The methods and systems disclosed herein are intended to solve such technical problems. The present application discloses innovative analytic tools that can be used by businesses to study how effective a branding, marketing, service, or sales strategy has been in improving customer loyalty and to evaluate performance of marketing channels or vehicles based on total sales volume and profit contribution as well as long-term customer loyalty creation.

In some embodiments, a platform comprises an input/output device, an operation unit implemented on one or more processing circuits including an Artificial Intelligence (AI) tool assistant, a code depository storing computer program modules, a computer-readable storage medium storing a database, and a model implementation library implemented by the one or more processing circuit.

The input/output device is configured to collect audio, visual, or electronic signals as a user inquiry. The database comprises first data in a first format collected from a customer relationship management (CRM) system storing second data in a second format and from a point-of-sale (POS) system storing third data in a third format. The model implementation library reformats the second data in the second format and the third data in the third format into the first format prior to storing the first data and the second data in the database.

The AI tool assistant may be configured to invoke existing AI models and build a plurality of AI tools through an application programming interface (API). The AI tool assistant may be configured to access multiple tools in parallel. In some embodiments the AI tool assistant is configured to access commercial AI models through the API, wherein a commercial AI model may be a large language model (LLM). In some embodiments, the plurality of AI tools are established prior to receiving the user inquiry and are ready to be utilized when the user inquiry is received. An AI workflow may be constructed based on the user inquiry. The plurality of AI tools may be constructed from the code depository.

In some embodiment, the plurality of AI tools include a search tool configured to query the database. The plurality of AI tools may further include a calculator tool configured to determine an activation score based on the first data by establishing a predictive algorithm based on the first data in the first format. The plurality of AI tools may include a calibration tool configured to calibrate a pre-established benchmark against a subset of the first data according to the user inquiry. The plurality of AI tools may further include a customer loyalty metric calculation tool for calculating a customer loyalty metric.

In some implementations, a data analysis method comprises collecting customer behavior data from a plurality of customers. Based on the collected customer behavior data, each customer is assigned a brand equity category selected from two or more brand equity categories. The method further comprises monitoring the number of customers assigned to each category and adjusting a marketing strategy to effectuate a shift in the number of customers assigned to each of the brand equity categories.

In some implementations, the customer behavior data comprises customer purchasing data. For example, the customer purchasing data may include customers' purchasing history and purchasing pattern.

In some embodiments, each of the two or more brand equity categories is assigned with a customer loyalty metric calculated based on the customer purchasing data. In one embodiment, the brand equity categories comprise the following four categories in the order of increased customer loyalty metric: prospects, casuals, loyalists, and cheerleaders.

In some embodiments, when monitoring the number of customers assigned to each brand equity category, the number of customers in each category is tallied first and a change in the number of customers in each category is recorded. In some embodiments, adjusting a marketing strategy to effectuate a shift in the number of customers assigned to each of the brand equity categories comprises adjusting a marketing strategy to move customers assigned to a brand equity category of a lower customer loyalty metric to a brand equity category of a higher customer loyalty metric. In some embodiments, whether the shift in the number of customers assigned to each of the brand equity categories is towards increased customer loyalty metrices is used to evaluate a marketing strategy.

The present application further discloses a data analysis system that comprises a memory for storing customer purchase data of a plurality of customers and one or more processors that are configured to perform data analysis of the customer purchase data.

In some embodiments, the one or more processors are configured to collect customer behavior data from a plurality of customers, select a category from two or more brand equity categories for each of the plurality of customers based on the collected customer behavior data and assign each customer to the selected brand equity category. The one or more processors are further configured to monitor the number of customers assigned to each category, and adjust a marketing strategy to effectuate a shift in the number of customers assigned to each of the brand equity categories. The one or more brand equity categories may be defined based on a customer-relationship model and each of the two or more brand equity categories is assigned with a customer loyalty metric. In one embodiment, the brand equity categories comprise the following four categories in the order of increased customer loyalty metric: prospects, casuals, loyalists, and cheerleaders. In one embodiment, a brand equity metric is calculated based on the customer-relationship model, the number of customers assigned to each brand equity category, and collected customer behavior data.

In some embodiments, the marketing strategy may be adjusted to migrate customers assigned to a brand equity category of a lower customer loyalty metric to a brand equity category of a higher customer loyalty metric.

In some embodiments, the one or more processors are further configured to analyze the collected customer behavior data for a first time period and for a second time period, calculate a first brand equity metric based on the customer behavior data for the first time period and a second brand equity metric based on the customer behavior data for the second time period, and compare the first brand equity metric and the second brand equity metric to evaluate a marketing strategy.

The present application also discloses a data analysis method that is based on a customer-relationship model. In the customer-relationship model, one or more brand equity categories are defined. The data analysis method includes the steps of collecting customer purchase data of a plurality of customers for a first time period, assigning each customer to one of the brand equity categories based on the collected customer purchase data, and calculating a first brand equity metric based on the customer-relationship model, the number of customers assigned to each brand equity category, and the collected customer purchase data.

In some embodiments, the data analysis method may include collecting sales data for the first time period, and calculating the first brand equity metric based on the customer-relationship model, the number of customers assigned to each customer-relationship category, the collected customer purchase data, and the collected sales data. The data analysis method may further include collecting customer purchase data and sales data for a second time period, assigning each customer into one of the brand equity categories based on the collected customer purchase data for the second time period, and calculating a second brand equity metric based on the customer-relationship model, the number of customers assigned to each brand equity category, and the customer purchase data and sales data collected for the second time period. The second brand equity metric is compared with the first brand equity metric and the performance of a business project is evaluated based on the comparison.

In some embodiments, in the data analysis method, the first and second brand equity metric comprise the number of customers in each of the brand equity categories in the first time period and the second time period respectively. The number of customers in each brand equity category in the first time period is compared with the number of customers in each customer-relationship category in the second time period.

In some embodiments, in the data analysis method, the business project is a marketing campaign. The marketing campaign is conducted during the second time period and the performance of the marketing campaign is evaluated by comparing the first brand equity metric evaluated during the first time period and the second brand equity metric evaluated during the second time period.

In some embodiments, a data analytic platform is disclosed to comprise an input/output device, an operation unit, a code depository, and a storage medium. The input/output device is configured to collect audio, visual, or electronic signals as a user inquiry. The operation unit is implemented on one or more processing circuits and comprises an Artificial Intelligence (AI) tool assistant. The code depository is configured to store computing program modules and the storage medium is configured to store a database of first data. The AI tool assistant is configured to invoke existing AI models and build one or more AI tools. The one or more AI tools may include a search tool configured to query the database. The one or more AI tools may also include a calculator tool configured to determine a customer activation score based on the first data.

In some embodiments, the calculator tool is configured to determine a customer activation score by: establishing a predictive algorithm based on the first data; selecting a category from two or more brand equity categories for each of the plurality of customers based on the collected customer behavior data and assigning each customer to the selected brand equity category using the predictive algorithm, wherein the two or more brand equity categories include a prospects category, and one or more customers assigned to the prospects category are potential customers who have not made a purchase; monitoring the number of customers assigned to each brand equity category and tracking a change in the number of customers in each brand equity category over time; and determining a customer activation score, wherein the customer activation score is determined based on a pre-established benchmark and the change in the number of customers over time in each brand equity category, and wherein the benchmark is established as a weighted sum of data of different markets, and weights used in the weighted sum are product, company, or market specific.

In some embodiments, the one or more AI tools may further include a calibration tool configured to calibrate the pre-established benchmark against a subset of first data according to the user inquiry.

In some embodiments, the one or more AI tools may be constructed from the code depository. The code depository may include a customer activation score calculator computer program module and the calculator tool invokes the customer activation score calculator computer program module to determine the customer activation score. In some embodiments, the code depository further includes a benchmark calibration computer program module and an AI tool in the one or more AI tools is configured to establish a benchmark by invoking the benchmark calibration computer program module. The benchmark may be calibrated against a subset of the first data and wherein the subset of the first data is identified for a time period or a market segment based on the user inquiry.

In some embodiments, the first data is collected by a customer relationship management (CRM) system and a point-of-sale (POS) system, and the first data comprises purchasing history and purchasing patterns of a plurality of customers. The one or more AI tools may further include a customer loyalty metric calculation tool for calculating a customer loyalty metric associated with each of the one or more brand equity categories.

In some embodiments, the AI tool assistant is configured to access multiple tools in parallel. The AI tool assistance is configured to access commercial AI models through an Application Programming Interface (API). For example, one of the commercial AI models is a large language model (LLM). In one embodiment, the user inquiry is received, for example, as an audio signal or another type of signal, and is interpreted or processed using the LLM model. The AI tool assistant builds a workflow in response to the user inquiry and the workflow utilizes one or more tools based on the user inquiry.

In some embodiments, a data analysis method starting with receiving a user inquiry through the input/output device as an audio, visual, or electronic signal. The data analysis method then constructs a workflow by an Artificial Intelligence (AI) tool assistant based on the received user inquiry, wherein the workflow utilizes one or more AI tools, and the one or more AI tools include an equity category prediction tool, a customer activation score calculator tool, and a benchmark calibration tool. The AI tool assistant may be configured to access commercial AI models through an Application Programming Interface (API).

The data analysis method further comprises selecting a category from two or more brand equity categories for each of the plurality of customers based on the collected customer behavior data and assigning each customer to the selected brand equity category by the equity category prediction tool, wherein the two or more brand equity categories include a prospects category and one or more customers assigned to the prospects category are potential customers who have not made a purchase. The number of customers assigned to each brand equity category is monitored and a change in the number of customers over time in each brand equity category is tracked.

The data analysis method then determines a customer activation score using the customer activation score calculator tool. The customer activation score is determined based on a pre-established benchmark and the change in the number of customers in each brand equity category over time. The benchmark is established as a weighted sum of data of different markets, and weights used in the weighted sum are product, company, or market specific and the benchmark is calibrated by the benchmark calibration tool against a subset of first data according to the user inquiry.

In some embodiment, the one or more AI tools include a customer loyalty metric calculation tool. The CRM data analysis method further comprises calculating, by the customer loyalty metric calculation tool, a customer loyalty metric associated with each of the one or more brand equity categories.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 illustrates various prior art business data analytics tools.

FIG. 2a illustrates prior art business data sets used in business data analytic tools.

FIG. 2b illustrates an example of customer data collected by a customer relationship management (CRM) system or a point of sale (POS) system.

FIG. 2c illustrates examples of CRM data, media data, customer order data.

FIG. 3a illustrates a customer-relationship model that defines a customer activation cycle.

FIG. 3b illustrates a customer activation cycle in which brand equity is quantified.

FIG. 3c illustrates an example of the results of a marketing campaign effectuating a shift of customers among different brand equity categories.

FIG. 3d illustrates an example of how to calculate Customer Activation Score™ (CAS™) using a benchmark.

FIG. 4a illustrates an exemplary customer-relationship model—the brand ecosystem model-being integrated into a business data analytic platform.

FIG. 4b illustrates an embodiment of the platform of FIG. 4a being connected to one or more devices;

FIG. 4c is a block diagram illustrating an exemplary implementation of the platform of FIG. 4a utilizing artificial intelligence.

FIG. 4d is a flowchart illustrating a process of building an AI workflow process.

FIGS. 5a-5b illustrate examples of collected customer data.

FIGS. 6a-6b illustrate results generated by a data analysis platform that implements the brand ecosystem model.

FIG. 7 illustrates a graphic user interface presenting the results generated by a data analysis platform that implements the brand ecosystem model.

FIG. 8 illustrates an example of a brand equity category.

FIG. 9 illustrates customer migration between different brand equity categories.

FIGS. 10a-10b illustrate a brand equity enhancing paradigm based on the brand ecosystem model.

FIG. 11 is a flow chart illustrating a CRM data analysis method.

### DETAILED DESCRIPTION

Embodiments of the disclosure are described more fully hereinafter with reference to the accompanying drawings, in which preferred embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

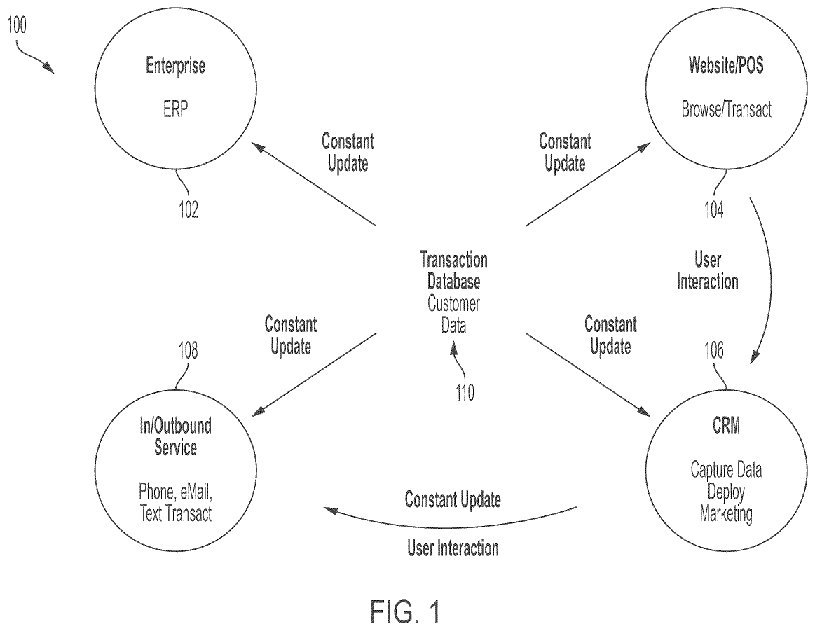

In referring to FIG. 1, a conventional business data analytic paradigm 100 is shown. The conventional data analytic paradigm 100 is built on a transaction database 110 of customer data. This database 110 collects customer data over time through constant updates received from different sources, for instance, business activities, website visits and transactions, marketing campaign deployment, and electronic communication. There exists commercially available software designed to capture data from these different sources. For example, enterprise resource planning (ERP) systems 102 are business management software that transforms and integrates functional units within an enterprise and collects transactional and management data from business activities inside the enterprise.

Software implemented on online web stores 104, such as point of sale (POS) systems, can capture customer browsing habits and clicking patterns, and collect transaction data such as sales items, sales date and time, purchase prices, and total dollar amount. The captured data can be fed into the transaction database 110 for storage and analysis.

Customer relationship management (CRM) systems 106 are important tools in marketing and sales. CRM systems 106 are designed to capture and analyze customer behavior, such as buying preferences, demographics, purchasing habits, etc. The customer behavior data captured by CRM systems 106 can be input into the transactional database 110 and integrated with other business data for comprehensive analysis.

With the rapid development of internet and wireless communication, most of today's businesses are conducted electronically. Electronic communications, such as emails, phone calls (over internet), text messages, are important transaction data and can be captured by applications installed at company routers or servers, which may be referred to as inbound/outbound service systems 108 in FIG. 1. Data captured by the inbound/outbound service systems 108 are valuable in business intelligence analysis.

While a large amount of customer data can be captured, stored, analyzed and made available to businesses, current enterprise software, such as CRM, POS, ERP, etc., is designed to guide a human operator to make certain correlations between disconnected data sets or data types, for example, helping a marketing department find the correlation between a marketing campaign launched in the second quarter and an increase in the revenue generated in the third quarter. Current enterprise software cannot be relied on to achieve insightful understanding. For example, a CRM system may be able to show customer purchasing patterns, but a CRM system cannot answer why customers are attracted to one particular brand or why customers prefer one brand over another. A CRM system may be able to measure whether immediately following a marketing campaign the sales volume has increased or not. But a CRM system cannot measure whether a marketing campaign or brand message increases long-term purchase behavior or not.

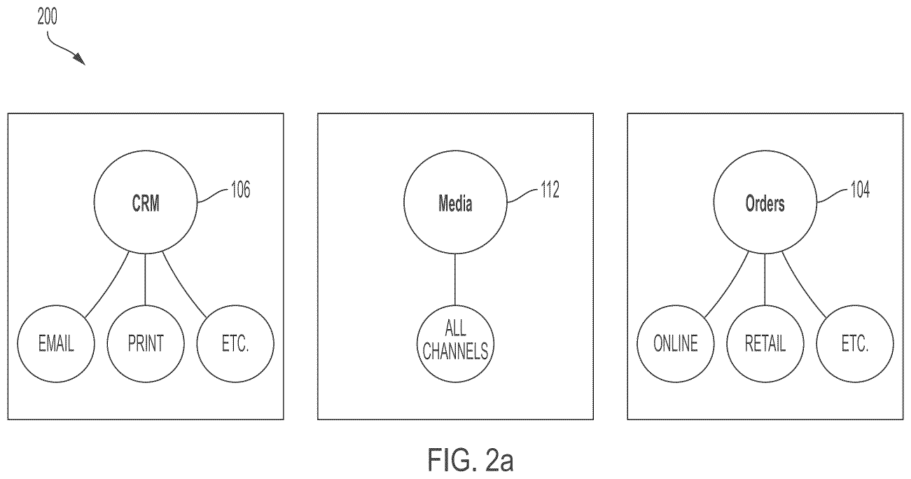

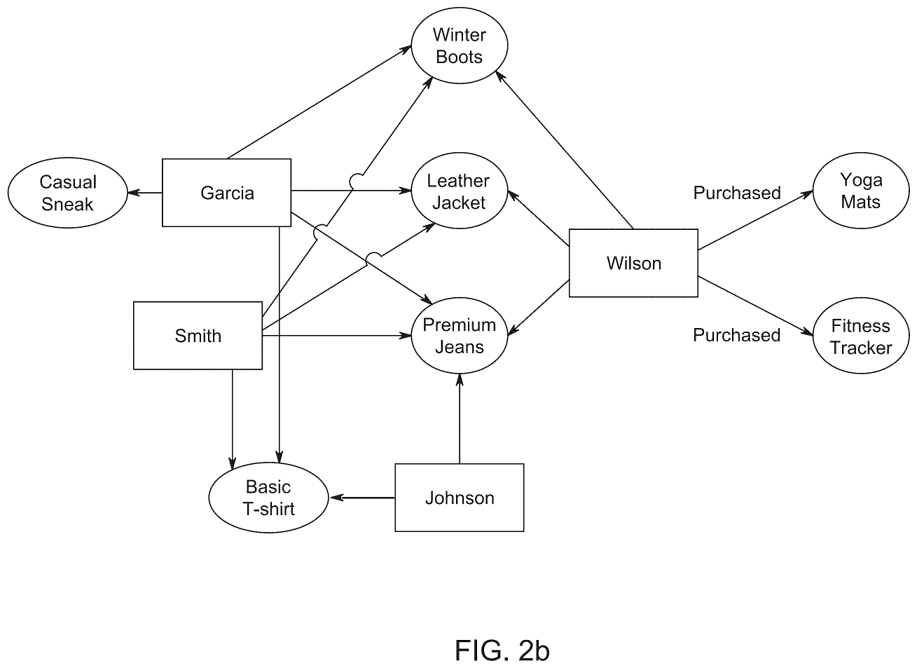

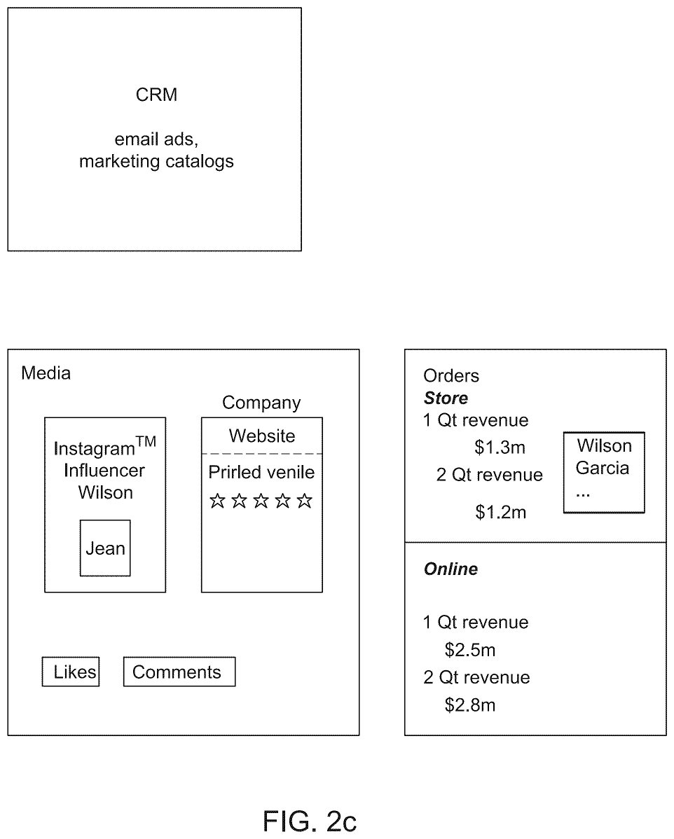

As shown in FIG. 2a, with conventional data analytic approaches, data collected from different sources are disjoined and disconnected. In FIG. 2a, a CRM system 106 collects and stores email, print and other materials. A media management system 112 manages communication channels. An ERP system 104 keeps track of the retail store purchases, online orders, etc. Current data analytic tools do not generate relation or connection between data collected from CRM system and that collected from POS or media or ERP systems. Those tools can amass and aggregate large data sets but fall short of generating insight. One common shortcoming in current data analytic tools, as previously mentioned, is the disconnected data sets and data types. This, and other shortcomings, cause the collected data and the analysis performed on the collected data to not reflect brand loyalty and to be unable to predict customer buying behavior.

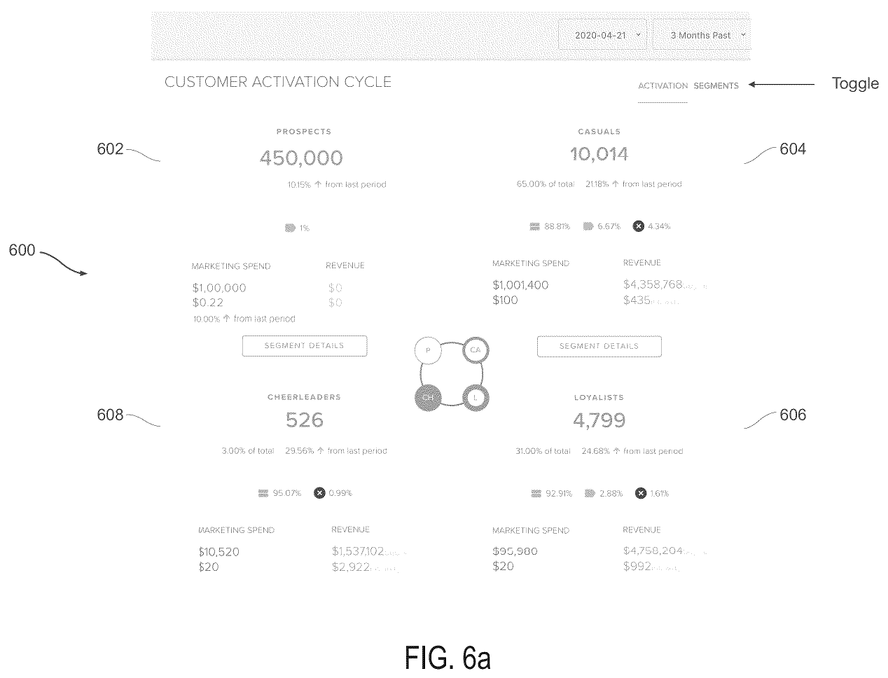

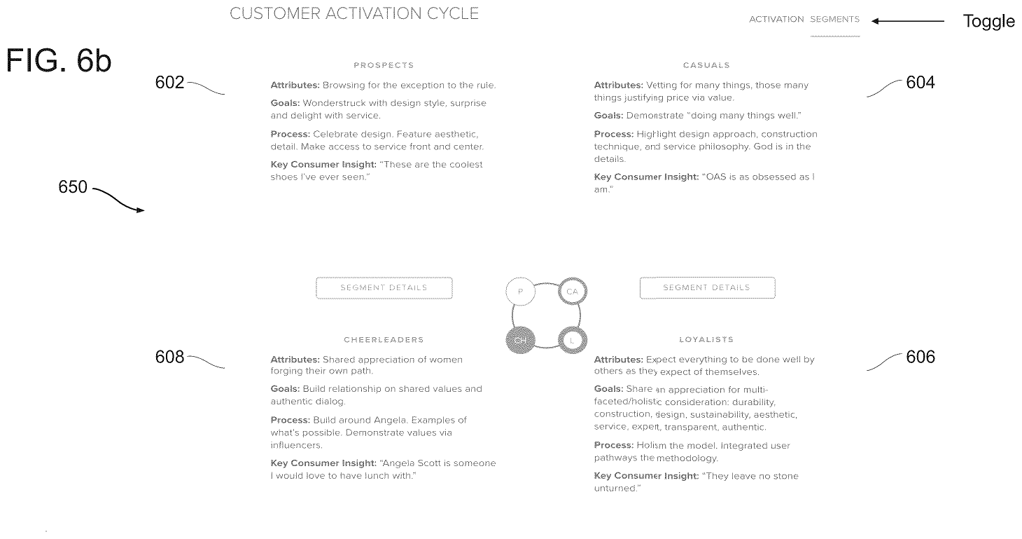

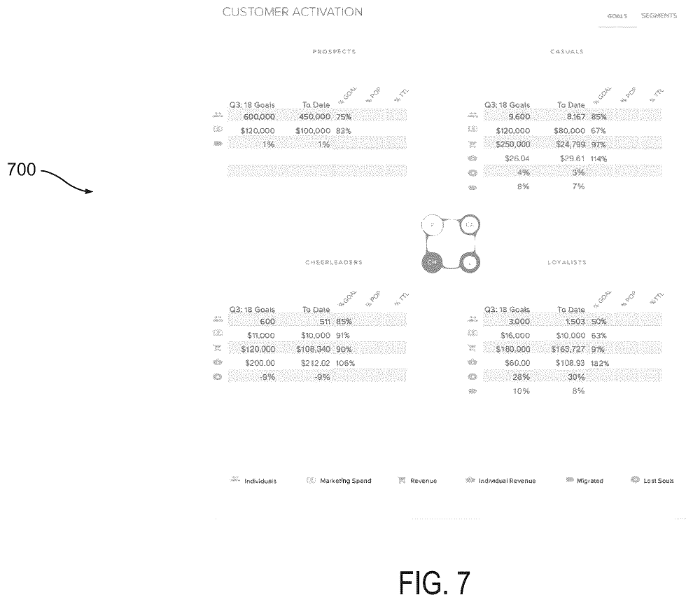

Brand loyalty, sometimes simply referred to as loyalty in the present application, is defined by repeat purchase behavior from individual customers maintained over time. The frequency, recency, and monetary value of purchase metrics are unique to different industries and product categories. Within a specific circumstance there are specific parameters for “loyal” frequency, recency, and monetary value (see FIGS. 6a, 6b, and 7 and the related discussions below). Quantitative measurements of brand loyalty depend on specific business settings, but can be defined and measured nonetheless. Currently, customer data is kept in the form of discrete purchases. As shown in FIG. 2b, records show individual customers Garcia, Smith, Johnson, and Wilson purchased various merchandise, such as winter boots, casual sneakers, leather jackets, premium jeans, Yoga mats, fitness trackers, basic T-shirts, etc. Aggregated data can also be generated to show total revenue from a single type of goods, from a single store, from all stores and all types of goods, etc. As shown in FIG. 2c, conventionally, an accounting system is configured to analyze sales data and generate aggregated revenue information such as the total revenue for the first quarter, the second quarter, etc. However, a conventional accounting system cannot correlate the revenue data or the trend of the revenue data with discrete purchase information collected by a CRM system or an ERP system.

Brand loyalty reflects how valuable a brand name is in the eyes of the customers. Higher brand loyalty makes a brand name worth more. In the present application, brand loyalty is measured by “brand equity,” i.e., the amount of equity a brand has accumulated, defined by how efficiently a brand creates a long-term buyer and brand advocate. Brand equity reflects a brand's value. To date, there is no industry standard measurement of brand loyalty or brand equity, which means there is no measurement of the correlation between what a brand does and the impact the brand contributes to brand loyalty, i.e., long-term repeat buying behavior.

In business-to-business (B2B) and business-to-consumer (B2C) businesses, brand equity may be defined as the efficacy by which a brand introduces itself to a potential customer (a prospect) and matriculates that customer to a state of loyal purchasing behavior. In some embodiments disclosed herein, a business can define two or more brand equity categories and classify each customer into one of the brand equity categories based on a customer loyalty metric. In one embodiment, two brand equity categories are defined: prospect and patron. The customer loyalty metric is the number of purchases made in the past 24 months. A customer is a prospect if he or she has not made a purchase in the past. A patron is someone who has made at least one purchase in the past 24 months.

In some embodiments, brand equity categories are defined with more granularities. For example, a business may define four brand equity categories: prospect, casual, loyalist, and cheerleader. The customer loyalty metric may be defined as the number of purchases made in the past 24 months, or the total amount spent on the brand, or the number of friends the customer introduced to the brand, or a weighted sum of some or all the above. In a brand ecosystem model, the objective is to move a potential customer through the brand equity categories with increased customer loyalty metrics, also referred to as the customer activation cycle in the present application.

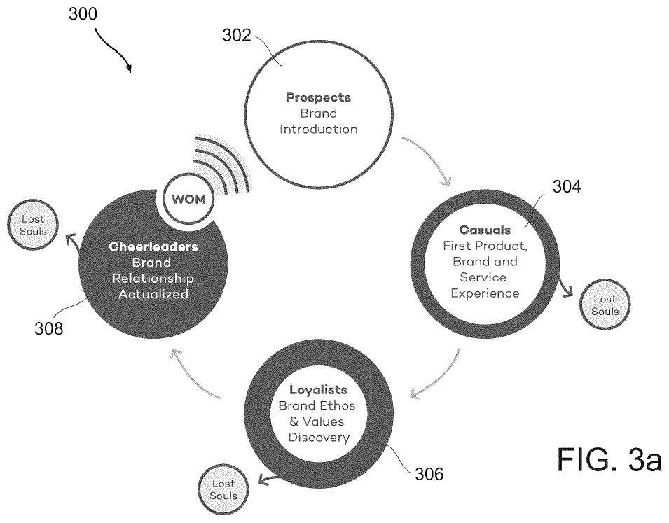

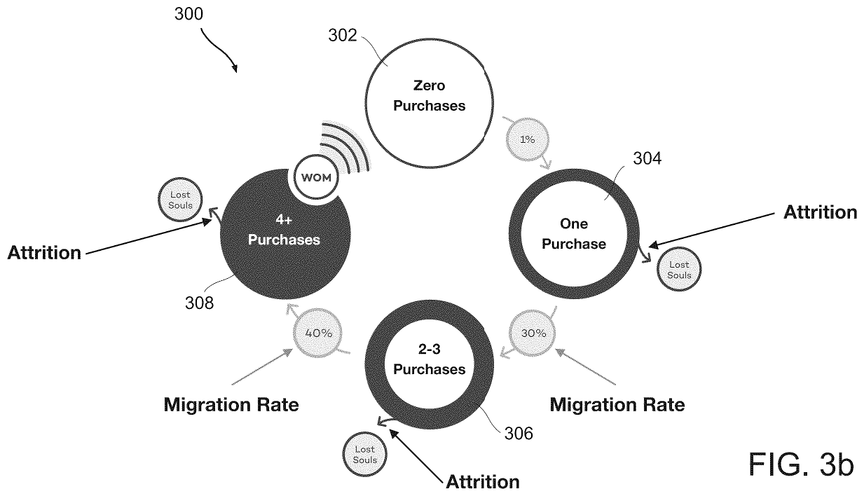

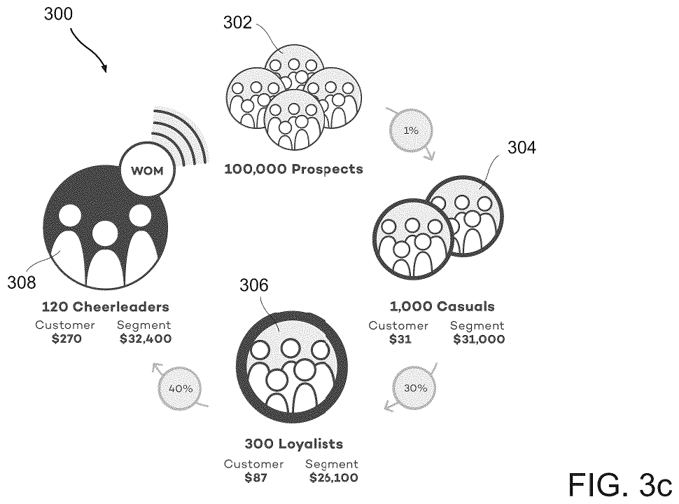

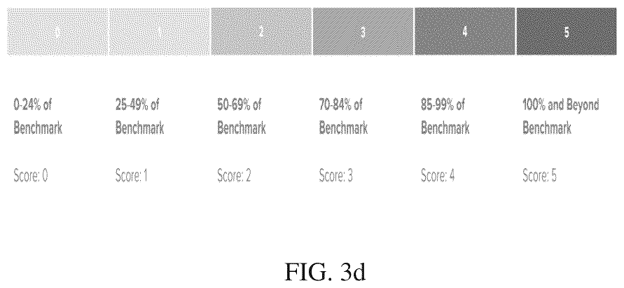

FIG. 3a illustrates an example of a customer activation cycle 300 for a particular brand. The customer activation cycle 300 includes four stages as the customers transition from one brand equity category to another brand equity category. At the initial stage, a potential customer is a prospect 302 who is not a buyer yet. Given motivation and encouragement, a prospect 302 can be introduced to the brand and goes through a first product/brand/service experience to become a casual buyer 304. When a prospect 302 does not become a casual buyer 304, he or she falls out of the customer activation circle and becomes a “lost soul.” In most cases, only a small percentage of the prospects 302 become a casual buyer 304. If a casual buyer 304 goes through a positive purchase, product, and customer service experience, they may make repeat purchases and become loyal to the product or brand and become a loyalist 306 of the product or brand. A loyalist 306 is a repeat and frequent buyer. A loyalist 306 often becomes loyal towards a brand because he or she has discovered the ethos and values that a brand represents and is attached to what the brand presents. Over time, a loyalist 306 may tell their friends or family about this product or brand and their good experience with it. They may also write good reviews on social media. The loyalist 306 after additional repeat purchases becomes a cheerleader 308. A cheerleader 308 embodies brand relationship actualization. A cheerleader 308 may influence prospects 302 and turn prospects 302 into casuals 304. In the customer activation cycle 300, between two adjacent stages, the migration rate can vary widely, depending on factors such as the industry, the product, the economic environment, etc. Examples of migration rates can be found in FIG. 3b, which also shows what are referred to as attrition rates along the activation cycle 300.

FIG. 3b provide simplified definitions of prospects 302, casuals 304, loyalists 306, and cheerleaders 308. Such definitions are also used as customer loyalty metrics for each brand equity category in this simple example. Each brand equity category is defined by the number of purchases made in the past 24 months. A casual buyer 302 is a customer who has made one purchase in the past 24 months. A loyalist 306 has made two to three purchases in the past 24 months and a cheerleader 308 has made at least four purchases. At each stage in the customer activation cycle 300, there is an attrition rate and a migration rate. Attrition refers to those who have stopped buying the brand, e.g., have not made at least one purchase in the past 24 months. Migration refers to the customers who have increased their buying frequency and have moved to the next brand equity category. Each brand equity category is given a customer loyalty metric. In FIG. 3b, the customer activation cycle 300 shows the qualification or definition of what is a casual buyer 304, a loyalist 306, or a cheerleader 308, which may be used as a customer-loyalty metric in some embodiments. In this example, customer loyalty metric is defined as the average number of purchases the customers in a brand equity category has made in a time period, e.g., 24 months. However, customer loyalty metric can also be defined differently. For example, customer loyalty metric can be defined as the average dollar amount spent on the brand. Customer loyalty metric may also include segment count (the number of customers in each category, the prospects, the casuals, loyalists, and cheerleaders), segment value (the dollar amount contributed by each category to revenue, profit, etc.), and migration rate (the percentage of customers in one brand equity category that have migrated to a higher brand equity category in a pre-defined time period).

In some embodiments, the migration rate of the cheerleaders category includes the retention rate of cheerleaders. In some embodiments, the migration rate of the prospects category includes the acquisition rate of prospects. These customer loyalty metrics provide quantitative measurements of what used to be just intuition, gut feeling, or discrete data points. By building a “composite” customer loyalty metric, which is an aggregate of two or more of these customer loyalty metrics, the customer loyalty to a specific brand name can be quantified and tracked.

Customer loyalty metric can also be defined as a weighted sum of two or more quantities. Customers show increased loyalty as they move along the activation cycle from a brand equity category of a lower customer loyalty metric to a brand equity category of a higher customer loyalty. However, only a fraction of customers in each category migrate to the next category. In FIG. 3b, from prospects 302 to casuals 304, only 1% migrated in a 24-month period. From casuals 304 to loyalists 306 about 30% migrated, and from loyalist 306 to cheerleaders 308 40% migrated in the same period.

FIG. 3c shows another exemplary customer activation cycle 300. In the example shown in FIG. 3c, only sales data are used in defining customer loyalty metrics. In more complex use cases, customer loyalty metric takes into consideration of customer behaviors such as referrals, social media recommendations, etc. In FIG. 3c, a casual buyer 304 is defined as a customer who on average spends $31 per quarter. A loyalist 306 spends $87 per year, more than double the amount spent by a casual buyer 304. A cheerleader 308 spends $270 per year. The total value of a brand equity category increases along the activation cycle 300. For the casual brand equity category 304, the total segment value for the time period is $31,000. The total segment value for the loyalist brand equity category 306 is $26,100 and the total segment value for the cheerleader brand equity category 308 is $32,400. In this customer activation cycle 300, out of the 100,000 prospects, 120 become cheerleaders 308. Along the activation cycle, 99% of the prospects 302 do not become casual buyer 304. 70% of the casual buyers 304 stay as casual buyers and 60% of the loyalists do not become cheerleaders.

Efficiency of the progression in the customer activation cycle 300 is the key to business success. The more efficiently customers migrate to the cheerleader category, the better a product or brand performs. The analytic tools and techniques disclosed here can be used to identify the progression of a prospect along the activation cycle 300 to becoming a loyal, long-term buyer—a cheerleader. The present application discloses a tracking and measurement system that can provide insight on the migration movement of customers along the cycle 300, for example, how long it takes to create a cheerleader out of a prospect, how much cheerleaders will spend in the next 24 months, how many cheerleaders will emerge over a given period of time, etc.

In the present application, the customer loyalty metric of each brand equity category: prospects, casual buyers (casuals), loyalists, or cheerleaders, reflects the affinity between an average customer in the category and the brand. Customer loyalty metrics reflect how much brand equity each customer or the customers in a brand equity category contribute to the total recognition or wellbeing of the brand. The tracking and measurement system based on the customer activation cycle 300 is built on a customer-relationship model referred to as the brand ecosystem model.

FIG. 3d illustrates an example approach for quantitatively measuring brand equity using the Customer Activation Score™ (CAS™) system, a proprietary software platform designed to provide quantitative measurements associated with the customer activation cycle shown in FIG. 3c. The CAS™ system includes a database that stores customer data collected from hundreds of companies over a decade. Based on the historical customer data, the CAS™ system establishes a benchmark for measuring the performance of the customer activation cycle. The benchmark is often industrial specific. For example, the benchmark for the food and beverage industry would be different from the benchmark established for the apparel industrial. The benchmark in FIG. 3d resembles a scale against which customer activation performance can be scored. For instance, the customer activation performance is given a score of 4 if the customer loyalty metric reaches 70-84% of the benchmark.

In the embodiment shown in FIG. 3d, the score range is 0 to 5. In another embodiment, the score range may be different, for example, from 0 to 500.

Benchmarks may be industrial specific, company specific, and/or product specific. Benchmarks are established based on empirical or historical data formatted according to a theory of a specific market. A benchmark often integrates different market data that measure various aspects of the market or product to be evaluated. Different market data may include revenues, the changing rate of revenues, the acceleration rate of revenue changes, individual customer purchase behaviors, individual customer social media behaviors, etc. Different market data may be integrated as a weighted sum, for example. The weights may be industrial specific, company specific, and/or product specific. The weights can be adjusted, improved, and fine-tuned as time goes on. A benchmark can be adjusted, improved, and fine-tuned as well.

For example, the casual category may have a much higher customer count than the other three categories. To prevent this high customer count in one particular category from skewing the overall CAS™ score, a lower weight may be applied to the metrics associated with the casual category. The weights may be used to establish benchmarks, or to calculate a brand equity metric used to obtain a CAS™ score against a benchmark.

In one exemplary embodiment, a benchmark is established based on customer data collected over a span of 24 months. The benchmark is a weighted sum of segment count, segment value and migration rate.

In some embodiments, a CAS™ score may be an average of the customer loyalty metrics calculated for the different equity categories.

The brand ecosystem model is a practical model that defines how a business relates to their end users. It is a scientific process that identifies the keys to how and why loyal customer behavior happens and provides a framework for business operators to apply the information in all aspects of their go to market efforts, measure the results, and adjust the information that goes to market such that customer performance is improved over time (customer performance being increased purchase behavior). The model as a whole allows for business managers to then refine their customers' experience of the brand, product, and service to create profitability and growth.

Long-term, maintained repeat buying patterns are the focus of the model. The brand ecosystem model defines why a customer will transact in response to what a brand does and what a brand says; and, it predicts if and why a customer will continue to buy repeatedly over time.

The model is a means to organize the entirety of what uniquely imparts value in the life of the customer and provides a detailed understanding of the messages and experiences that matter most in terms of creating a lasting purchase pattern between the brand and its customer. By illuminating how a brand particularly can engender a following, brand managers can methodically apply the information contained in the brand ecosystem model to the totality of their interactions with customers in distribution channels (retail, ecommerce, etc.), marketing vehicles (email, social channels, paid print and digital marketing, etc.), and customer service environments, optimizing the performance of the business holistically.

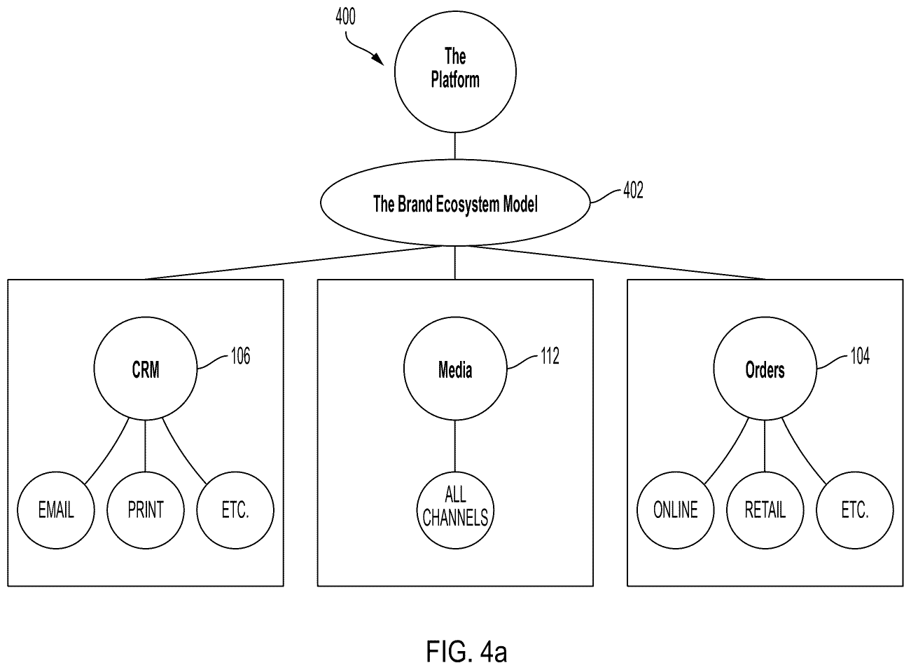

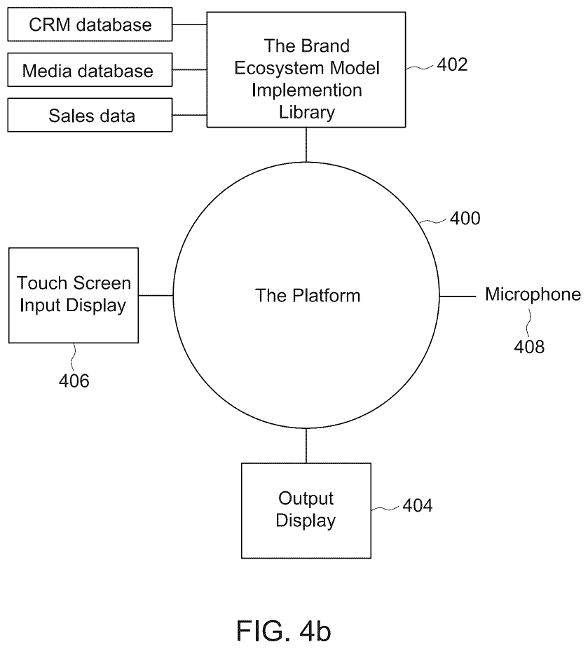

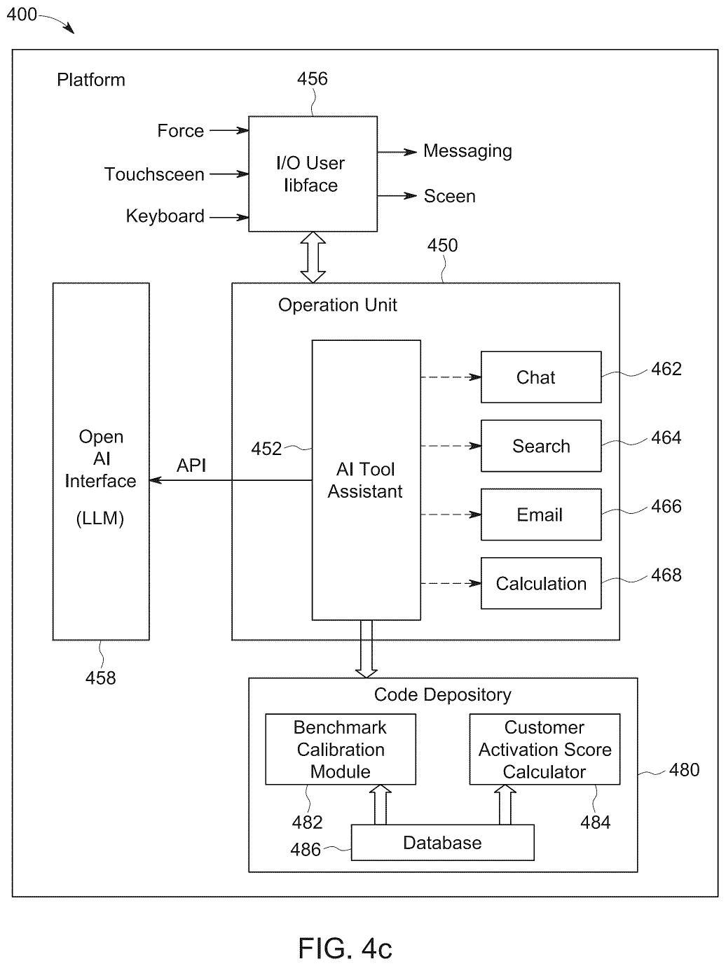

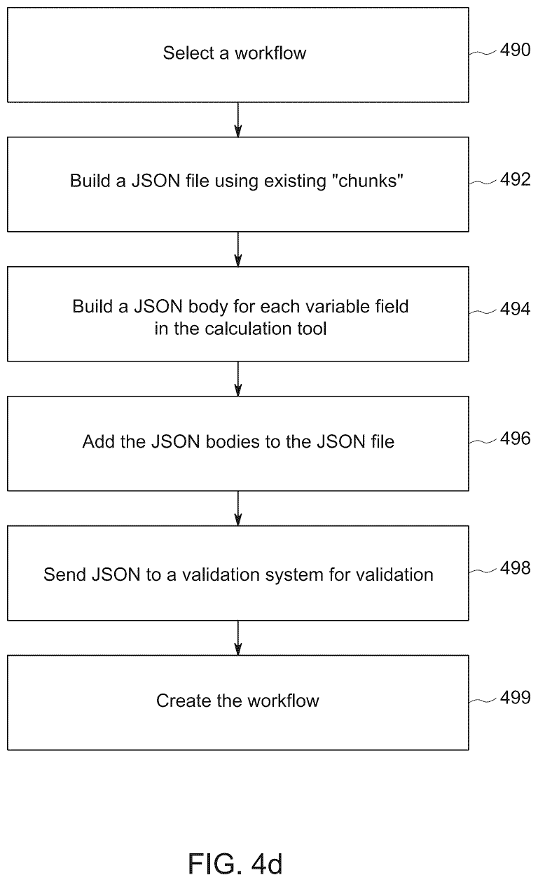

FIG. 4a is a block diagram illustrating a data analytic platform 400. The platform 400 is built on the brand ecosystem model 402 to integrate data collected from disconnected sources (see FIG. 2) and generate insightful reports and useful measurements to facilitate business planning and management. FIGS. 4b-4d illustrate embodiments of the platform 400. In FIG. 4b, the platform 400 is shown to be connected to one or more input/output devices such as an output display screen 404, a touchscreen input display 406, and a microphone 408. The platform 400 is also connected to a brand ecosystem model implementation library 402 that is configured to provide analysis and calculation related to brand equity. The brand ecosystem model implementation library 402 comprises computation program modules and are configured to communicate with existing CRM, ERP, POS, and media systems. The brand ecosystem model implementation library 402 may be configured to read data from these systems and store the data in a database. In some embodiments, the brand ecosystem model implementation library 402 reformats the data from different systems into data of a uniform format before storing the data in the database. The reformatting of the data to a uniform data format advantageously allows for correlation of data from disparate systems, as well as allowing for the streamlining and automation of data analysis. In some embodiments, the brand ecosystem model implementation library 402 is implemented as a code depository 480 shown in FIG. 4c.

In referring to FIG. 4c, an embodiment of the platform 400 comprises an operation unit 450, an I/O user interface 456, an OpenAI interface 458, and a code depository 480. The operation unit 450 includes an AI tool assistant 452. The AI tool assistant 452 is configured to rely on the code depository 480 to build different tools. Depending on the specific code depository 400, the tools built by the AI tool assistant 452 may vary. In some embodiments, the code depository 408 is implemented as the brand ecosystem model implementation library 402 shown in FIG. 4b. For example, the code depository 408 may include a benchmark calibration module 482 and a customer activation score calculator 484. The code depository 480 may further include a database 486 that stores customer data collected by CRM, ERP, POS, and media systems. The computation modules 482 and 484 rely on the customer data stored in the database 486 during operation.

The AI tool assistant 452 receives a user inquiry through the I/O user interface 456. The user inquiry may be a voice command received via a microphone, a command typed on a keyboard, a text message or an input received on a touchscreen. The AI tool assistant 452 is configured to invoke existing AI models, some of which may be commercially available, for example, large language model, decipher the user inquiry, and construct an AI workflow based on the user inquiry. The AI workflow utilizes AI agents, also referred to as tools, to accomplish tasks related to the user inquiry. Examples of the tools include a chat tool 462, a search tool 464, an email tool 446, a calculator tool 468, etc., as shown in FIG. 4c.

In one embodiment, the calculator tool 468 is configured to determine a customer activation score based on the customer data stored in the database 486. In one embodiment, a calibration tool (not shown in FIG. 4c) is configured to calibrate a benchmark against a subset of customer data.

In some scenarios, one or more tools may be established prior to receiving the user inquiry and are ready to be utilized by the AI workflow when the user inquiry is received. This enhances the platform's response time to the user inquiry by eliminating the time needed for generating the one or more tools after receiving the user inquiry. In other scenarios, the AI workflow is configured to create a new tool in response to the user inquiry. The new tool utilizes computation modules stored in the code depository 480 and performs one or more functions required by the user inquiry. FIG. 4d illustrates an example flowchart illustrating the process of the AI tool assistant 452 constructing an AI workflow in response to a user inquiry.

In FIG. 4d, the AI tool assistant 452 selects a workflow among a plurality of workflows that are available (step 490). A workflow may be a thread or a running computing thread. The AI tool assistant 452 then builds a JavaScript Object Notation (JSON) file using existing JSON file objects (step 492). Multiple JSON file objects may be grouped into a “chunk.” For each agent/tool, the AI tool assistant 452 builds a JSON file object for each variable field required by the agent/tool (step 494) and adds the JSON file objects to the JSON file associated with the workflow (step 496). When finished, the JSON file is sent to a validation system, e.g., OpenAI, for validation (step 498). Once validated, the workflow can be created using the validated JSON file (step 499).

The platform 400 is equipped with AI capabilities that are implemented in the AI tool assistant 452 and coupled with the brand equity analytic functionalities that are embodied in the code depository 480. The platform 400 is configured to analyze huge amounts of customer data collected from a range of diverse big data software and present analytical results in the brand equity analytic framework through AI interface.

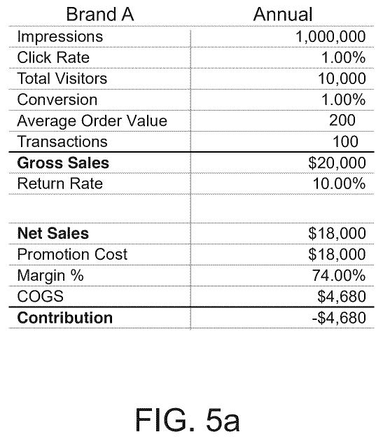

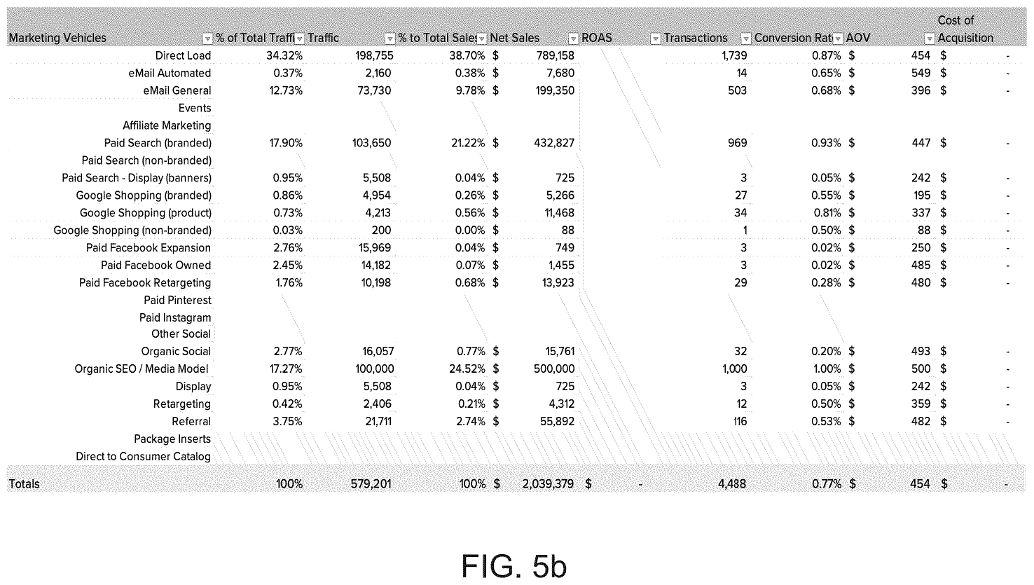

As shown in FIG. 1 and also in FIGS. 5a and 5b, conventional big data software can capture huge amounts of data from different sources. There are performance data from e-commerce channel, performance data from wholesale channel, data on market spending, etc. There are also data from different time periods, data from different geographic regions, etc.

For example, FIG. 5a is a table showing channel performance data collected for Brand A in a period of one year. For a particular marketing channel, for example, running an advertisement at an ESPN website. During the one-year period, there are 1 million viewers. 1% of the viewers clicked on the advertisement and visited the company's website. Out of the 10,000 visitors, a hundred of them made a purchase at an average order value of $200, which generated gross sales of $20,000 and net sales of $18,000. The cost of goods sold is $4,680, and the promotion cost was $18,000 netting a negative contribution of −$4,680.

FIG. 5b is another example that data analysis, however complex and exhaustive, does not provide insight into customer purchase behavior. FIG. 5b shows performance of various marketing vehicles and suggests some marketing vehicles, e.g., direct load and paid search (branded), are more effective than other marketing vehicles, e.g., automated email. However, the marketing vehicle performance data does not show whether the sales are merely casual purchases. FIG. 5 provides no guidance on which vehicle is the most inductive to long-term customer loyalty or why.

FIGS. 6a and 6b presents exemplary results generated by the data analytic platform 400 after integrating and assimilating disparate data sets, such as those shown in FIGS. 5a and 5b. In FIG. 6a, a customer activation cycle 300 is generated based on customer and marketing data that may be extracted or imported from a data warehouse. The data may be collected from thousands, hundreds of thousands, or even millions of customers or potential customers. Through analysis, the data analytic platform 400 generates analytic results based on the brand ecosystem model 402 and presents the results in the graphic user interface (GUI) 600 and 650 as shown in FIGS. 6a and 6b.

As shown in the GUI 600 of FIG. 6a, the analytical results are presented in four brand equity categories: prospects 602, casuals 604, loyalists 606, and cheerleaders 608. The number of customers, revenue, and marketing spend are calculated for each of these brand equity categories to illustrate the development or deterioration of customer relationship with a particular product or brand. For each brand equity category, there are specific parameters for “loyal” frequency, loyal recency, and loyal monetary values. These parameters can be used in calculating the customer loyalty metrics for the brand equity categories.

As shown in FIG. 6a, in the first brand equity category 602, there are 450,000 prospects identified and a marketing campaign is launched to increase the number of prospects and to obtain their contact information for future marketing purposes. The marketing campaign is given a budget of $100,000 or $0.22 per prospect, a 10% increase over the past time period. FIG. 6a shows there is a 10.15% increase of the number of prospects at the end of the marketing campaign. Among the 450,000 prospects, 1% have migrated to become casual buyers.

In this particular analysis, the revenue generated by a casual buyer, i.e., the customer loyalty metric, is $435 in a 24-month period. For different consumer products and industries and brands, the results will vary. The brand ecosystem model is quantifying value in this instance to enable a diagnostic insight to be concluded regarding what the brand manager can do to increase these values. The same would be true for the values of loyalists 306 and that of cheerleaders 308. However, it is noted that all the numbers shown are given as examples for illustration purposes only.

Pertaining to the second brand equity category 604, a marketing campaign that targets casual buyers is launched to increase revenue. The marketing campaign has a budget of $1,001,400 ($100.00 per buyer). During the time period the campaign is run, the total revenue generated from the 10,014 casual buyers has reached $4,358,768 ($435 per buyer). Also, during the marketing campaign, the data analytic platform reports that 6.67% of the casual buyers have become loyalists but 4.34% has stopped making purchases and has become “lost souls.”

In the third brand equity category 606, loyalists, the data analytic platform 400 reports that there are 4,799 customers who fit the definition of loyalist and their purchases generate $4,758.204 of revenue (an average of $992 per customer). The marketing campaign targeted at this brand equity category has a spending of $95,980 ($20 per customer). The platform also reports that among the 4,799 loyalists, 2.88% have become cheerleaders and 1.61% have stopped purchasing during the reporting period.

In the fourth brand equity category 608, cheerleaders, the platform 400 reports that there are 526 cheerleaders during the reporting period. The marketing spending is $10,520, equivalent of $20 per customer and the total revenue from the customers in this category is $1,537,102, which translates to $2,922 per cheerleader, and, during this reporting period, the category has lost 0.99% of customers.

The report in the GUI 600 of FIG. 6a shows a snapshot of data collected during a specific time period. The report also captures migration of customers along the path of the customer activation cycle 300. During the time period, the report shows shifts of customers in between the brand equity categories and the losses in each of the categories as well.

The GUI 650 of FIG. 6b illustrates how the data analytic platform 400 can provide in-depth analysis and insightful understanding by integrating the disparate data sets 104, 106, and 112 and assimilating them through the brand ecosystem model 402. Under each brand equity category, summaries generated based on the brand ecosystem model 402 are presented. The summaries include key customer insights that reflect the levels of customer loyalty and brand equity associated with each brand equity category. The views of GUI 600 and GUI 650 can be toggled back and forth using the buttons “ACTIVATION” and “SEGMENTS” located at the top right corner of the interfaces.

FIG. 7 shows a different graphic user interface (GUI) 700 generated by the data analytic platform using different sets of data collected for a different time period, e.g., the third quarter of 2018. In FIG. 7, the marketing campaign goals are listed next to the customer sales data for comparison, so the effectiveness of the marketing effort can be easily evaluated, and the progress can be easily gauged. For example, one of the Q3.2018 goals is to reach 600,000 prospects. The report shows that 450,000 prospects have been contacted to date and that is 75% of the goal. For another example, in the cheerleader brand equity category, the Q3.2018 goal is to acquire 600 cheerleaders. To date, the category has 511 cheerleaders, that is 89 below the goal. While the total revenue in this category is also short of the $120,000 goal, the spending per customer is above the goal.

In the GUI 700, the collected customer data is analyzed to showcase the shift of the number of customers between brand equity categories that are defined using common CRM/ERP data, e.g., revenue, spending, etc. In an overly simplistic approach, brand equity category may be viewed as market segments classified based on monetary values. But as described earlier, brand equity category is not simply a market segment classified based on monetary values. A brand equity category is defined by brand equity metric that take into consideration of monetary value, sustained purchasing frequency, etc. Brand equity measures customer loyalty and the brand equity categories—prospects, casuals, loyalists, cheerleaders, etc.—categorize customers according to their relationship, affinity, and loyalty to the brand. Although a cheerleader may spend more on the concerned brand than an average loyalist, a high-spending customer does not necessarily become a cheerleader, if the amount of spending is due to the amount of available budget, not the appreciation of the brand. Brand equity emphasizes loyal purchasing behavior, the efficacy that a brand introduces itself to a potential customer, and the affinity that a brand attracts from an existing customer. Data associated with brand equity categories provide more in-depth analysis than previous enterprise data analytic tools.

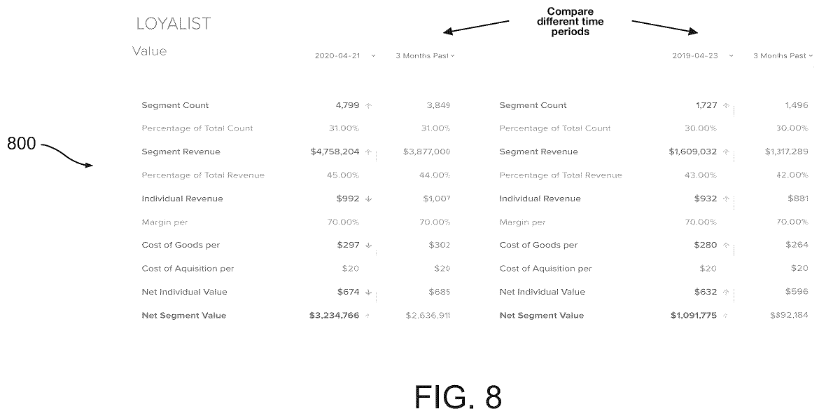

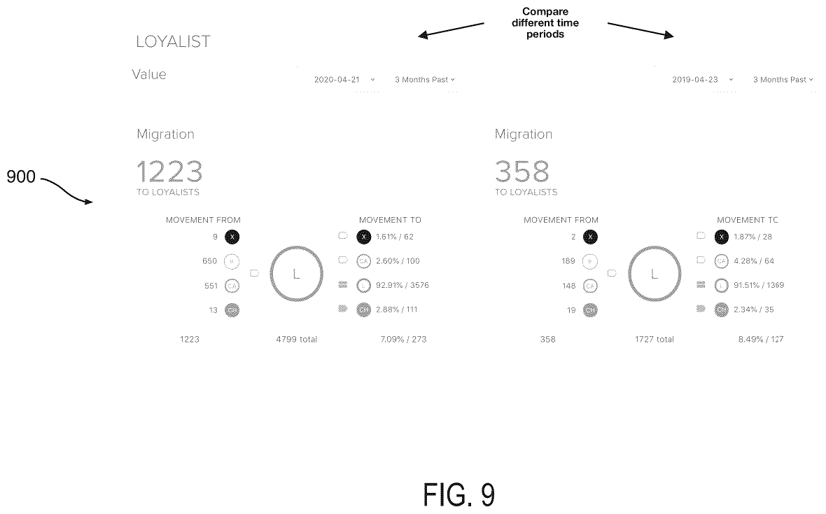

FIG. 8 and FIG. 9 together illustrate an example of the in-depth data analysis in connection with the loyalist brand equity category. The GUI 800 shows complex data analytic results along with a summary of business intelligence—strategic insight (FIG. 9)—learned from the data analytic results. The strategic insights emphasize on strengthening the relationship between the customers and the brand. One measurement of the relationships between the customers and the brand is the distribution of customers among the multiple brand equity categories. With that, the strengthening or weakening of the relationships can be measured by the changes in the distribution of customers among the multiple brand equity categories, or the shifts of the number of customers from one category to another.

As shown in FIG. 8, analytic results of one brand equity category, loyalists 306, is presented as an example. The parameters that are reflective of customer loyalty are listed. The “loyal” parameters include how many customers are in the loyalist brand equity category, the percentage of loyalists among all customers, the revenue generated from this brand equity category, the percentage of revenue from this brand equity category in the total revenue, revenue per customer in this category, etc. One of the important indicators of customer loyalty is net segment value. When comparison is made between two time periods, April 2019 and April 2020, the net segment value shows significant improvement, from $1,091,775 to $3,234,766. The number of loyalists also shows significant increases, from 1,727 to 4,799.

FIG. 9 presents more details on the shifts of the number of customers in the loyalist brand equity category. The number of customers who moved into, moved out of, and who have stopped purchasing are listed for two time periods. In the first time period (the table on the left side), among the number of customers who have moved into the loyalist brand equity category, 650 coming from the prospect brand equity category, 551 from the casual brand equity category and 13 from the cheerleader brand equity category. In the first time period, there are 273 customers who have moved out of the loyalist brand equity category, with 100 going into the casual category, 111 into the cheerleader category and 62 who have stopped making purchases. In the same time period, 3576 loyalists have stayed in the same brand equity category. With the addition of 1223 loyalists, the total number of customers in the loyalist brand equity category reaches 4799. When being compared with the second time period (the table on the right side), the improvement of the loyalist brand equity category, hence the brand equity embodied by this brand equity category, is apparent.

It is again noted that in the present application, four brand equity categories are used as an example to illustrate the advanced data analytic approaches and tools disclosed herein. The number of brand equity categories and the names used for the categories are not restricted or limited to the embodiments described herein.

Plenty of real-life examples have demonstrated that prior art analytic approaches often obscure what is truly happening underneath the change of the total revenue. For example, Brand EB was a famous brand for outdoor wears and gears, and recently fell behind other famous brands such as Patagonia and Columbia. One of their business strategies was expansion into malls in order to attract more shoppers. While the expansion generated more customers, the gained customers are in the casual brand equity category, not the loyalist or cheerleader category. This is because the core customers of EB are avid outdoor expeditioners, not average mall visitors. The expansion eventually failed to improve the adoption of loyalist and cheerleader brand equity categories and EB's business as a result overall. Had the advanced data analytic tools disclosed herein been used, EB might have been able to spot the weakness of its business strategy earlier and made adjustments to address the weakening loyalty metrics.

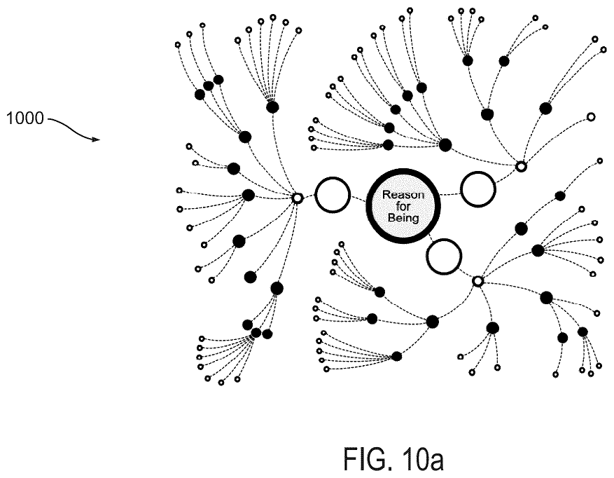

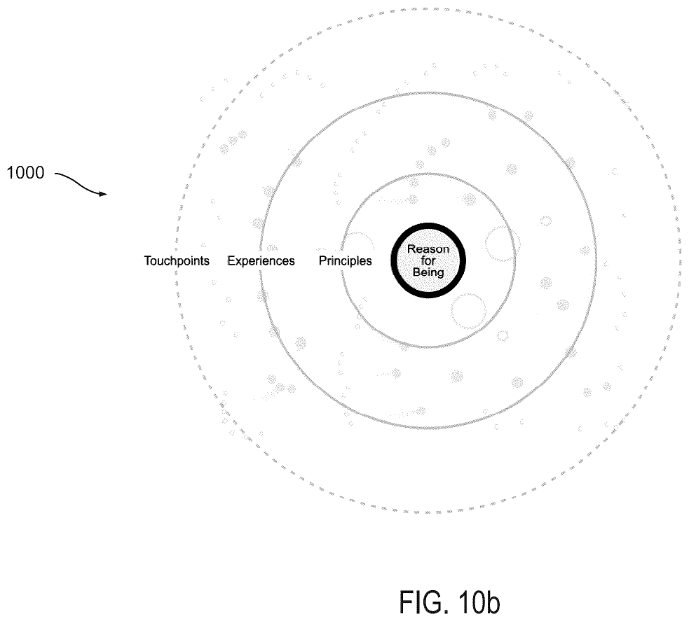

The data analytic tools and methods disclosed herein utilizes brand equity and the brand ecosystem model and can direct marketing and business strategies towards treating customer loyalty as equity and managing customers as assets. FIGS. 10a and 10b together illustrates a map that allows a company to create a business plan based on the brand ecosystem model and build up growth from its core business value. The map is called the story universe 1000 and it allows a company to define events that are most relevant to and most effectively advocate the company's core value (referred to in the drawing as “the reason for being.”)

In order to create a predictive algorithm, the customer activation cycle 300 needs to make order out of the huge amount of data. The story universe presented in FIGS. 10a and 10b is a visual representation of that order. Customers have their own unique relationships with brands. But cheerleaders share the same milestone experiences and information that triggered them to move from prospect to casual to loyalist to cheerleader. By asking a series of questions of representative cheerleaders and listening intently to them describe their relationship, their experiences, their interpretations of the brand, a host of common threads emerge. Interviews have uncovered the keys in a brand ecosystem. The common threads serve as the fodder for defining the needs of each segment and the milestone experiences that lead to migration at each stage. The architecture of the customer experience can be seen now intuitively emanating from the center to the fringe of the story universe paradigm 1000. The first and most important driving force of every single story out on the fringe that every customer potentially can experience, whether they are a prospect, casual, loyalist or cheerleader is a direct result or manifestation or outcome of the core value at the center. The center of the story universe paradigm 1000 represents the principle of company, product, and service.

The story universe paradigm 1000 in FIGS. 10a-10b provides guideline on designing and architecting the tangible experiences of the customer that can lead a customer to progress over time to become a cheerleader. In that progress, four different milestones can be defined. The four different milestones represent increased brand equity that have been built up. The four different milestones also correlate with the four stages shown in the customer activation cycle 300. The first milestone shown in FIG. 10b is “touchpoints,” which refer to an interaction between an audience (a prospect) and the brand. The second milestone is “experiences.” After multiple touchpoints, the customer begins to experience the brand, through purchasing or interaction with the brand, product or service. The customers are casual buyers. The third milestone is principles. This is where the customers are becoming loyalists and are starting to see the distinction between the brand and other brands. The last milestone is “reason for being,” where the customers see the values and principles the brand stands for and are becoming cheerleaders.

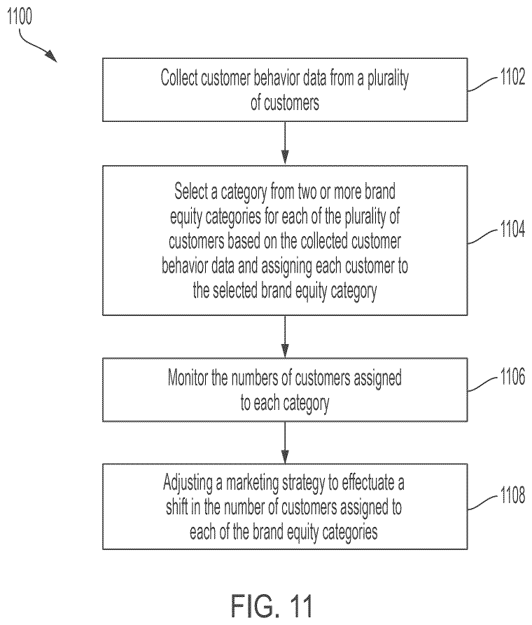

FIG. 11 is a flowchart illustrating an exemplary data analytic method 1100. In the data analytic method, customer behavior data is collected from a plurality of customers (step 1102), which may include potential customers, i.e., the prospects. Customer behavior data may include customer purchasing data, for instance, dollar amount, frequency, and time and location. Based on the collected customer behavior data, each customer is assigned a brand equity category selected from two or more brand equity categories (step 1104). As time goes on and more data is collected, the category assigned to each customer may change and the number of customers assigned to each category is monitored (step 1106). The change of the distribution of customers in the brand equity categories is studied and used to adjust marketing strategies to effectuate a desired shift in the distribution.

In some embodiments, the data analysis method may include collecting sales data for the first time period, and calculating the first brand equity metric based on the customer-relationship model, the number of customers assigned to each customer-relationship category, the collected customer purchase data, and the collected sales data. The data analysis method may further include collecting customer purchase data and sales data for a second time period, assigning each customer into one of the brand equity categories based on the collected customer purchase data for the second time period, and calculating a second brand equity metric based on the customer-relationship model, the number of customers assigned to each brand equity category, and the customer purchase data and sales data collected for the second time period. The second brand equity metric is compared with the first brand equity metric and the performance of a business project is evaluated based on the comparison.

Although the disclosure is illustrated and described herein with reference to specific embodiments, the disclosure is not intended to be limited to the details shown. Rather, various modifications may be made in the details within the scope and range of equivalents of the claims and without departing from the disclosure.

What is claimed is:

1. A platform, comprising:
an input/output device configured to collect audio, visual, or electronic signals as a user inquiry;
an operation unit implemented on one or more processing circuits, comprising an Artificial Intelligence (AI) tool assistant;
a code depository storing computing program modules;
a computer-readable storage medium storing a database comprising first data in a first format collected from a customer relationship management (CRM) system storing second data in a second format and a point-of-sale (POS) system storing third data in a third format; and
a model implementation library implemented by the one or more processing circuits to reformat the second data in the second format and the third data in the third format into the first format prior to storing the second data and the third data in the database;
wherein the AI tool assistant is configured to invoke existing AI models and build a plurality of AI tools through an application programming interface (API), and the AI tool assistant is configured to access multiple AI tools in parallel.

2. The platform of claim 1, wherein the plurality of AI tools include a search tool configured to query the database.

3. The platform of claim 1, wherein the plurality of AI tools include a calculator tool configured to determine an activation score based on the first data in the first format by establishing a predictive algorithm.

4. The platform of claim 1, wherein the plurality of AI tools include a calibration tool configured to calibrate a pre-established benchmark against a subset of the first data according to the user inquiry.

5. The platform of claim 1, wherein the plurality of AI tools further include a customer loyalty metric calculation tool for calculating a customer loyalty metric.

6. The platform of claim 1, wherein the AI tool assistant is configured to access commercial AI models through the API.

7. The platform of claim 6, wherein one of the commercial AI models is a large language model (LLM).

8. The platform of claim 1, wherein the plurality of AI tools are established prior to receiving the user inquiry and are ready to be utilized when the user inquiry is received.

9. The platform of claim 1, wherein an AI workflow is constructed based on the received user inquiry.

10. The platform of claim 1, wherein the plurality AI tools are constructed from the code depository.

11. A data analytic platform, comprising:
an input/output device configured to collect audio, visual, or electronic signals as a user inquiry;
an operation unit implemented on one or more processing circuits, comprising an Artificial Intelligence (AI) tool assistant;
a code depository storing computing program modules; and
a storage medium storing a database of first data;
wherein the AI tool assistant is configured to invoke existing AI models and build one or more AI tools;
wherein the one or more AI tools include a search tool configured to query the database;
wherein the one or more AI tools include a calculator tool configured to determine a customer activation score based on the first data by:
establishing a predictive algorithm based on the first data;
selecting a category from two or more brand equity categories for each of the plurality of customers based on the collected customer behavior data and assigning each customer to the selected brand equity category using the predictive algorithm, wherein the two or more brand equity categories include a prospects category, and one or more customers assigned to the prospects category are potential customers who have not made a purchase;
monitoring the number of customers assigned to each brand equity category and tracking a change in the number of customers in each brand equity category over time; and
determining a customer activation score, wherein the customer activation score is determined based on a pre-established benchmark and the change in the number of customers over time in each brand equity category, and wherein the benchmark is established as a weighted sum of data of different markets, and weights used in the weighted sum are product, company, or market specific; and
wherein the one or more AI tools include a calibration tool configured to calibrate the pre-established benchmark against a subset of first data according to the user inquiry.

12. The data analytic platform of claim 11, wherein the one or more AI tools are constructed from the code depository.

13. The data analytic platform of claim 12, wherein the code depository includes a customer activation score calculator computer program module and the calculator tool invokes the customer activation score calculator computer program module to determine the customer activation score.

14. The data analytic platform of claim 13, wherein the code depository further includes a benchmark calibration computer program module and an AI tool in the one or more AI tools is configured to establish a benchmark by invoking the benchmark calibration computer program module.

15. The data analytic platform of claim 14, wherein the benchmark is calibrated against a subset of the first data and wherein the subset of the first data is identified for a time period or a market segment based on the user inquiry.

16. The data analytic platform of claim 11, wherein the first data is collected by an CRM system and a point-of-sale (POS) system, and the first data comprises purchasing history and purchasing patterns of a plurality of customers.

17. The data analytic platform of claim 11, wherein the one or more AI tools further include a customer loyalty metric calculation tool for calculating a customer loyalty metric associated with each of the one or more brand equity categories.

18. The data analytic platform of claim 11, wherein the AI tool assistant is configured to access multiple tools in parallel, and is configured to access commercial AI models through an Application Programming Interface (API).

19. The data analytic platform of claim 11, wherein one of the commercial AI models is a large language model (LLM).

20. The data analytic platform of claim 11, wherein the user inquiry is received as an audio signal, the AI tool assistant builds a workflow in response to the user inquiry, and the workflow utilizes one or more tools based on the user inquiry.
